(19) United States
(12) Patent Application Publication
(10) Pub. No.: US 2007/0255695 A1
(43) Pub. Date: Nov. 1, 2007

(54) METHOD AND APPARATUS FOR SEARCHING IMAGES

(76) Inventors: CHIH-LIN HU, Tai-Nan City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/740,913

(22) Filed: Apr. 26, 2007

(30) Foreign Application Priority Data
Apr. 28, 2006 (TW) 095115347

(51) Int. Cl. G06F 17/30

(52) U.S. Cl. 707/3

(57) ABSTRACT

A method for searching images applicable to a file database includes receiving an image file including an image section and an image information section, receiving an identification information, forming a tag in the image information section according to the identification information, storing the image file into the file database, and inputting a search information to search the file database for selecting the image file when the tag conforms to the search information.

### BACKGROUND OF THE INVENTION

1. Field of the Invention

The invention relates to a method and apparatus for searching images, and more particularly, to a method and apparatus for increasing the efficiency of searching images.

2. Description of the Prior Art

As the technique of image process revolutionizes and the image capturing device advances, traditional films have been gradually replaced by digital photos. The formation of digital photos typically involves transforming the information including brightness and color of an image through adequate compression into digital data and eventually producing a corresponding digital image file. By storing digital image files in storage medium such as optical discs and hard drives, the digital image files can be browsed or processed in the future. However, as the volume of digital image files piles up in the storage medium, searching a particular digital photo ultimately becomes a time-consuming task.

If a user wishes to find a specific photo from hundreds or thousands of digital image files, an image browsing software is often utilized to browse all of the digital photos until the specific photo is found. Since the names of the digital image files are mostly meaningless and do not display the content of the image, utilizing the image browsing software to browse through all of the photos is often a time consuming and inefficient task. For instance, after conventional image capturing devices such as digital cameras or scanners capture a volume of digital images, different file names are assigned to each digital image automatically by the image capturing device, in which the file names are typically composed of a combination of numbers and English alphabets, such as DSCN1211.jpg, DSCN1212.jpg, and DSCN1213.jpg. The file names are not associated with the content of the image, thus finding a particular image by searching through numerous unrelated file names would become a difficult task. Despite the fact that users may relate the file name of the image with the content of the image, the task of searching through millions of images is still another time consuming task.

Typically, a method of searching an image database according to the file name of the image is performed on the basis that the user already knows the name of the file and the image processing system already includes a filing system. The fact of having these restrictions unavoidably increases the utilization range and the convenience of the method. In order to resolve this problem, conventional technique has provided a way of distinguishing images by comparing data provided by the user to retrieve the desired image file. Nevertheless, this type of search method involves complicated algorithms that the users must have a rough picture regarding the image being searched, which further restricts the usable range of the method.

### SUMMARY OF THE INVENTION

It is an objective of the present invention to provide a method and apparatus for searching images.

A method for searching images applicable to a file database is disclosed. The method includes: obtaining an image file having an image section and an image information section; obtaining an identification information; forming a tag in the image information section according to the identification information; storing the image file into the file database; and inputting a search information to search the file database for selecting the image file when the tag matches the search information.

An image processing system connected to a file database is disclosed. The image processing system includes an image receiver for obtaining an image file having an image section and an image information section; an identification information generator for generating an identification information; a tag generator for forming a tag within the image information section according to the identification information and storing the image file in the file database; and an image searching device to input a search information for searching the file database and selecting the image file while the tag matches the search information.

A method for searching images applicable to an image database is disclosed. The image database includes a plurality of image files, in which each image file comprises an image section and an image information section. The method includes: receiving a search command corresponds to a first image file having a first image section and a first image information section, wherein the first image information section comprises at least one tag; comparing the tag to every image information section of the image files; and outputting the corresponding image file while the tag matches the data within the image information section.

An image searching apparatus is disclosed. The image searching apparatus is connected to an image database having a plurality of image files, in which each of the image files has an image section and an image information section. The image searching apparatus includes: an input device for receiving a search command, in which the search command corresponds to a first image file having a first image information section, wherein the first image information section stores at least one tag; a comparison device for comparing the tag and each image information section of the image files, and an output device for outputting corresponding image file while at least one tag matches the data within the image information section.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram of an image file according to the prior art.

FIG. 2 illustrates an image searching workflow according to an embodiment of the present invention.

FIG. 3 illustrates a perspective view of an image processing system according to an embodiment of the present invention.

FIG. 4 illustrates an image searching workflow according to an embodiment of the present invention.

FIG. 5 illustrates a perspective view of an image searching device according to an embodiment of the present invention.

FIG. 6 illustrates an image searching workflow according to an embodiment of the present invention.

### DETAILED DESCRIPTION

It is an objective of the present invention to create meaningful information within the image information section of an image file, thereby allowing users to determine whether an image file satisfy the search request.

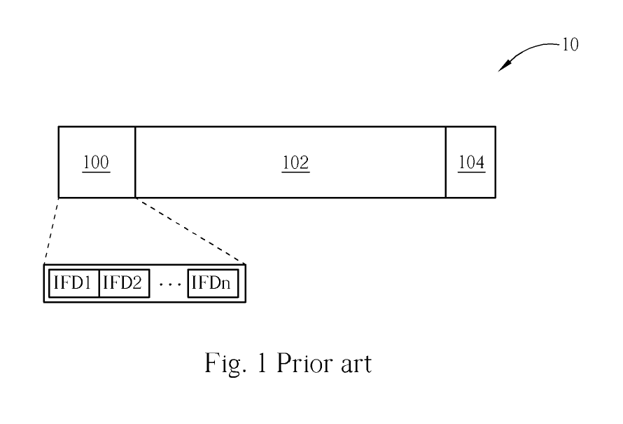

Please refer to FIG. 1. FIG. 1 is a perspective diagram of an image file 10 according to the prior art. The image file 10 qualifies the Exchangeable Image File Format, in which the image file 10 includes an image information section 100, an image section 102 and/or a padding section 104. The image section 102 records the main image data of the image file, in which the main image data can be data stored in a compressed or uncompressed form. The padding section 104 packages the image file 10 into a plurality of packets with fixed sizes according to the size of the image section 102. The image information section 100 includes a plurality of tags IFD1 to IFDn, in which each of the tags contains the property information for each image stored in the image section 102. The property information for the images include image type, resolution, bit depth, compression method, data source, generating method, and longitude and latitude. The tags IFD1 to IFDn also include empty tags for expansion purpose in the future.

Preferably, specific tags describing the traits of the image file are generated in the image information section 100 according to the characteristics of the image file stored in the image section 102 and while a search is performed, specific image file 10 can be selected according to the tags.

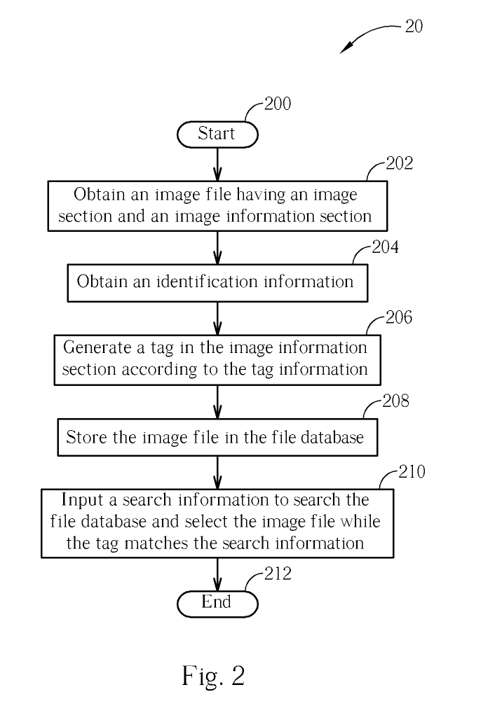

Please refer to FIG. 2. FIG. 2 is an image searching workflow 20 according to an embodiment of the present invention. The image searching workflow 20 is applicable to a file database, in which the image searching workflow includes the following steps:

Step 200: Start.

Step 202: Obtain an image file having conventional image file structures including image section and image information section shown in FIG. 1.

Step 204: Obtain an identification information relating to the content of the image section.

Step 206: Generate a tag in the image information section according to the tag information.

Step 208: Store the image file in the file database.

Step 210: Input a search information to search the file database and select the image file while the tag matches the search information.

Step 212: End.

According to the image searching workflow 20, a tag is generated and recorded in the image information section of an image file according to the corresponding identification information of the image file. By doing so, when a search is performed on the file database, information stored in the image information section of each image file can be searched and the image file carrying the search information can be output directly. In other words, the present invention specifically stores the identification information that describes the characteristics of the image file in the form of a tag within the image information section of the image file. By comparing the tag within the image information section and the search information input by the user, the image file carrying corresponding information can be retrieved directly. Despite the fact that there are circumstances when users are unable to search a particular image file according to the file name of such image, such as when the image file stored in the file database carries an undistinguishable file name such as DSCN1211.jpg, DSCN1212.jpg, or DSCN1213.jpg, or the file database does not include a filing system, the present invention is able to easily overcome this problem by comparing the tags and the search information to obtain the desired file. Moreover, the file name of the image file can be changed according to the tag contained within the image information section and a search can be performed according to the newly altered file name.

Preferably, the identification information of step 204 is disclosed corresponding to a characteristic of an image file. For instance, the identification information can be coordinates information of an image file when the file is generated, and a map system having conversion function for coordinates and geographical location can be utilized to retrieve the location information of the aforementioned coordinates information. The location information can be administrative setting names of a site, a scenery, or a building, whereas the coordinates information can be information of different latitudes, longitudes, or heights. In other words, information such as longitude, latitude and height during which the image is captured can be converted to meaningful word descriptions and recorded in the image information section. Hence, as long as the search information contains the name of the particular site or scenery, the image file having corresponding information can be retrieved. Additionally, identification information can also be any form of information input by the user, including characters or sounds.

According to an embodiment of the present invention, the identification information can be assigned to a corresponding reference image, such that when a comparative value between the image section and the reference image is greater than a predetermined value, the tag can be assigned according to the identification information. In other words, the database of the reference image can be predetermined. If the data stored in the image section of the image file is related to the reference image, a tag can be recorded in the image information section of the image file according to the reference image. For instance, if a user goes to Paris and takes some pictures of the Eiffel Tower, the user could assign an identification information “Eiffel Tower” to a reference image of the Eiffel Tower. The reference image is then compared with the photographic image taken by the user, such that when the comparative value of the photographic image is greater than a predetermined value, a tag containing “Eiffel Tower” is added into the image information section of the photographic image. By following this method, if the user wishes to find information regarding Eiffel Tower in the future, he or she only needs to input the search information “Eiffel Tower” to retrieve the corresponding Eiffel Tower pictures from the image file. The aforementioned comparison steps can be adjusted according to the size of the reference image for obtaining an optimal comparative value.

According to an embodiment of the present invention, the identification information can be assigned to a captured image taken from a portion of the image section. Preferably, each of the reference images includes a reference label and when the comparative value between the captured image and a reference image is greater than a predetermined value, a tag is assigned according to the captured image. In other words, the present invention is able to utilize a portion of the image taken from the image section to determine whether the image is related to a particular theme and decide the setting of the tag. For instance, a plurality of bird images is first stored, in which each image contains a corresponding label. After an image of a bird is taken, a captured image is assigned by tracing the outline of the bird. The captured image is then compared with the stored bird images, such that when the comparative value is greater than a predetermined value (representing that the captured image is related to a particular bird image), the corresponding label is assigned to the image information section of the captured image. Hence, if a search is conducted to find the image file, users only need to input the name of the bird and the aforementioned image file can be retrieved.

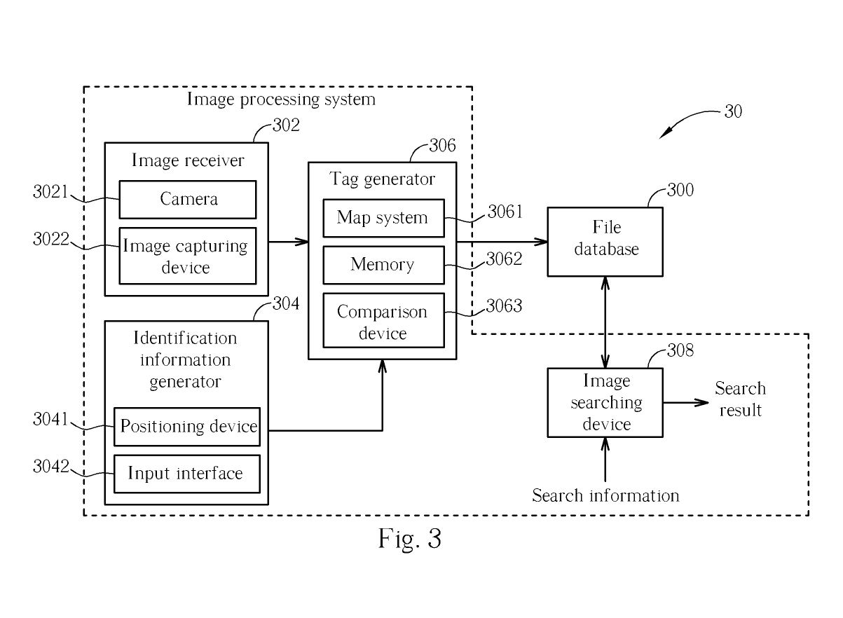

Please refer to FIG. 3. FIG. 3 illustrates a perspective view of an image processing system 30 according to an embodiment of the present invention. The image processing system 30 is established to implement the workflow 20. Connected to a file database 300, the image processing system 30 includes an image receiver 302, an identification information generator 304, a tag generator 306, and an image searching device 308. The image receiver 302 includes a camera 3021 and an image capturing device 3022 for extracting image files having both image section and image information section. The identification information generator 304 includes a positioning device 3041 and an input interface 3042 for extracting the identification information. The tag generator 306 includes a map system 3061, a memory 3062, and a comparison device 3063 for forming tags in the image information section of the image files according to the identification information generated by the information generator 304 and storing the image files in the file database 300. The image searching device 308 is used to input a search information to search for the file database 300, such that when the tag of an image file within the file database 300 matches the search information, an action is taken by outputting the matching image file. Hence, the image processing system 30 preferably creates a tag in the image information section of the image file according to the corresponding identification information of the image file and then stored the image file in the image database 300. By following this method, a comparison can be made between the tags and the search information when a search is conducted by the image searching device 308 and corresponding image file having matched information can be extracted. In other words, the image processing system 30 is able to output the identification information containing descriptions regarding characteristics of the image file and store the information in the form of tags in the image information section of the image file. The image searching device 308 can compare the search information input by the user and the tag to retrieve the corresponding image file. Despite the file name of the image file stored in the file database 300 is unreadable or the file database 300 does not have a filing system such that the users are unable to search for a particular image file according to its file name, the method of the present invention is able to compare the tag and the search information for retrieving the desired file.

In the image processing system 30, the positioning device 3041 is used to retrieve an image file while generating and assigning a coordinates information as the identification information, the map system 3061 is used to store a plurality of coordinates information with respect to a plurality of location information, and the tag generator 306 is used to assign a location information in the map system 3061 as tag according to the coordinates information obtained by the positioning device 3041. Preferably, the image processing system 30 is able to convert information such as longitudes, latitudes, and heights into meaning word descriptions and store these information in the image information section. Hence if a search is conducted, the user only needs to input the name of a particular site or scenery to retrieve the corresponding image file have matched information.

The memory 3062 is used to store a plurality of reference images, and the comparison device 3063 can be used to compare an image section and a reference image stored by the memory 3062 for generating a comparative value. If the comparative value is greater than a predetermined value, the tag of the image section is assigned to include the identification information corresponding to the reference image. In other words, the image processing system 30 is able to predetermine the database of the reference image, such that if the data recorded in the image section of the image file relates to the reference image, a tag can be formed in the image information section of the image file according to the reference image.

Additionally, the image capturing device 3022 is used to extract a portion of the image from the image section. The comparison device 3063 then compares the captured image and the reference images stored in the memory 3062 to generate a comparative value and when the comparative value is greater than a predetermined value, the tag within the image section is assigned to include the identification information corresponding to the reference image. In other words, the image processing system 30 is able to assign the tag by determining whether the tag relates to a particular theme according to the portion of the image from the image section. For instance, in bird photography, a plurality of bird species can be assigned previously, and after a captured image is compared and related to a particular bird species, the tag is then assigned with the name of such bird species. Hence, if a search is conducted to look for a particular image file, the user only needs to input the name of the bird species and the corresponding image file having matched information can be retrieved.

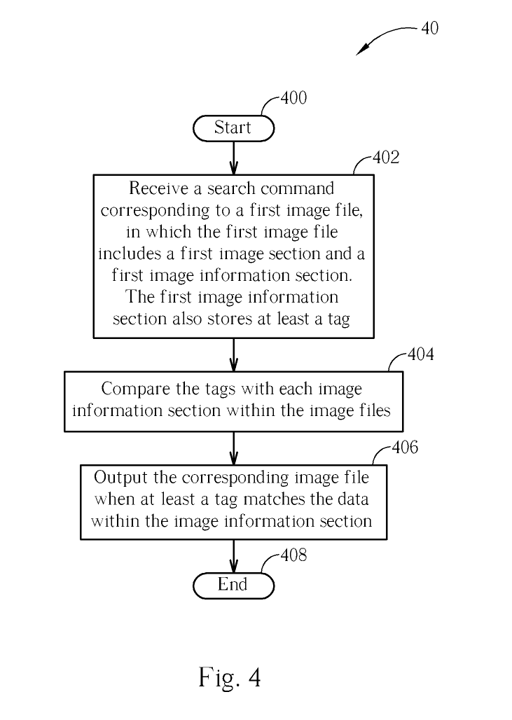

A search flow associated with the image searching device 308 is describe in FIG. 4. FIG. 4 illustrates an image searching workflow 40 according to an embodiment of the present invention. The image searching workflow 40 is targeted to an image database having a plurality of image files, in which the each of the image files includes an image section and an image information section. The image searching workflow 40 includes the following steps:

Step 400: Start.

Step 402: Receive a search command corresponding to a first image file, in which the first image file includes a first image section and a first image information section. The first image information section also stores at least a tag.

Step 404: Compare the tags with each image information section within the image files.

Step 406: Output the corresponding image file when at least a tag matches the data within the image information section.

Step 408: End

According to the image searching workflow 40, after the search command is received, a comparison is conducted by determining whether the target of the search command matches the data within the image information section of a particular image file within the image database. If a match is confirmed, an action is taken by outputting the corresponding image file. In other words, the image searching workflow 40 determines whether the tag within the image information section of the image file matches the data (such as word descriptions or sound descriptions) input by the user and then output the image file that matches such description. Therefore, despite the fact that the name of the image file stored in the image database is unreadable or the fact that the image database does not include a filing system, the present invention could still compare the image information section of the image file and the information input by the user and retrieve the desired image file.

If the image file does not include a tag, the image search workflow 40 could obtain an identification information and form a tag in the image information section according to such identification information. The identification information can be location information, reference image information, or captured image information.

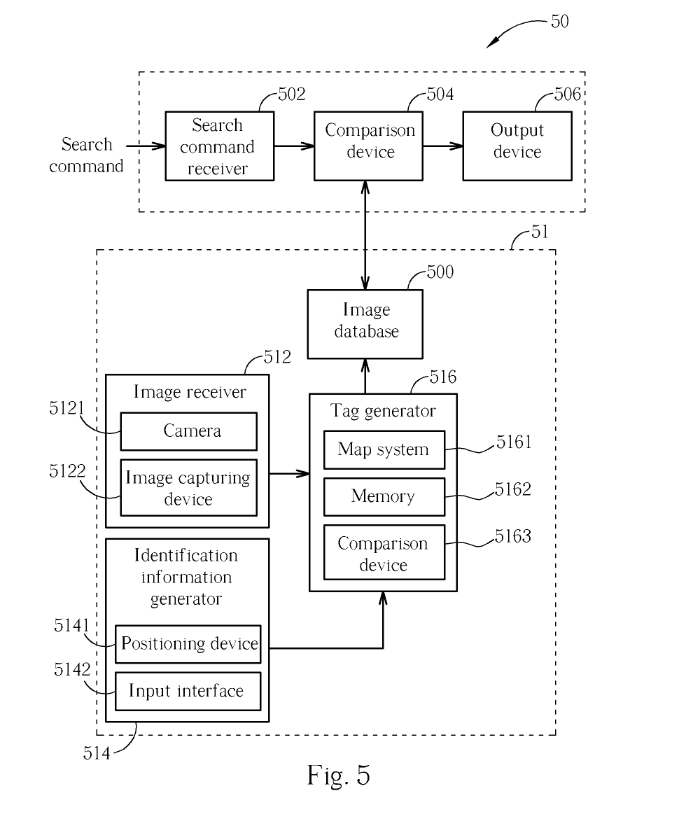

An implementation of the image search workflow 40 is described in FIG. 5. FIG. 5 illustrates a perspective view of an image searching device 50 according to an embodiment of the present invention. The image searching device 50 is connected to an image database 500 storing a plurality of image files, in which the image database 500 is located within an image processing system 51 and each of the image files includes an image section and an image information section. The image searching device 50 includes a search command receiver 502, a comparison device 504, and an output device 506. The search command receiver 502 is used to receive a search command corresponding to a first image file, in which the first image file contains a first image information section having at least a tag therein. The comparison device 504 is used to compare the tag and each image information section of the image file within the image database 500. The output device 506 is used to output a corresponding image file while a tag matches the data within the image information section.

In addition to the image database 500, the image processing system 51 also includes an image receiver 512, an identification generator 514, and a tag generator 516. The image receiver 512 is used to obtain image files having image section and image information section. The identification generator 514 having a positioning device 5141 and an input interface 5142 is used to obtain identification information. The tag generator 516 having a map system 5161, a memory 5162, and a comparison device 5163 is used to form a tag in the image information section of the image file according to the identification information generated by the tag generator 514 and store the image file in the image database 500. The positioning device 5141 is used to generate coordinates information and assigning the coordinates information as the identification information while the image file is obtained. The map system 5161 is used to store the coordinates information corresponding to the plurality of location information, and the tag generator 516 is used to obtain a location information from the map system 5161 and assign the location information as the tag according to the coordinates information obtained from the positioning system 5141. Preferably, the image processing system 51 is able to take information such as latitudes, longitudes, and heights with respect to the condition to which the image files is obtained and convert these information into meaningful word descriptions and record these descriptions in the image information section. Ultimately, if a search is conducted, the user only needs to input the specific name of the site or scenery to retrieve the corresponding image file. The memory 5162 is used to store a plurality of reference images, the comparison device 5163 is used to compare an image section and a reference image stored by the memory 5162 and output a comparative value based on the result of the comparison. If the comparative value is greater than a predetermined value, the tag within the image section is assigned to include the identification information corresponding to the reference image. The comparison device 5163 is used to compare the captured image and the plurality of reference images stored in the memory 5162 and generate a corresponding comparative value respectively. If the corresponding comparative value is greater than a predetermined value, the tag within the image section is assigned to include the identification information corresponding to the reference images. In other words, the image process system 51 is able to determine whether a particular theme is associated according to a portion of the image of the image section and assign the tag accordingly. For instance, in bird photography, a plurality of bird species can be assigned previously, and after a captured image is compared and related to a particular bird species, the tag is then assigned with the name of such bird species. Hence, if a search is conducted to look for a particular image file, the user only needs to input the name of the bird species and the corresponding image file having matched information can be retrieved.

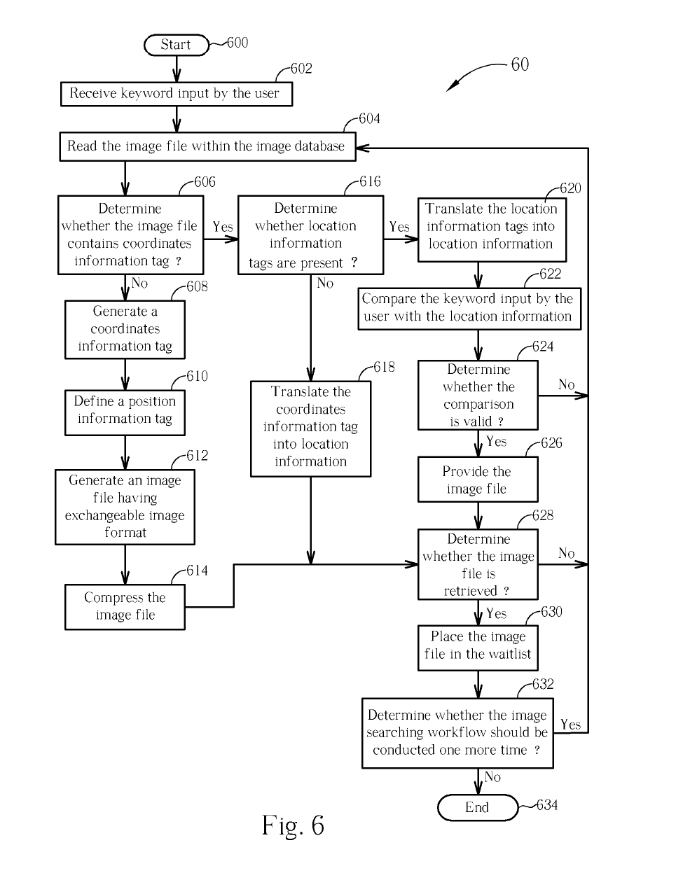

FIG. 6 illustrates an image searching workflow 60 according to an embodiment of the present invention. The image searching workflow 60 preferably searches through the image file within an image database according to the location keyword, in which each image file contains an image section and an image information section. The image searching workflow 60 includes the following steps:

Step 600: Start.

Step 602: Receive keyword input by the user.

Step 604: Read the image file within the image database.

Step 606: Determine whether the image file contains coordinates information tag. If no tags are found, proceed to Step 608. If tags are found, proceed to Step 616.

Step 608: Generate a coordinates information tag.

Step 610: Define a position information tag.

Step 612: Generate an image file having exchangeable image format according to the coordinates information tag generated by Step 608 and the position information tag generated by Step 610.

Step 614: Compress the image file.

Step 616: Determine whether location information tags are present. If no tags are present, proceed to Step 618. If tags are found, proceed to Step 620.

Step 618: Translate the coordinates information tag into location information.

Step 620: Translate the location information tags into location information.

Step 622: Compare the keyword input by the user with the location information.

Step 624: Determine whether the comparison is valid. If yes, proceed to Step 626. If no, return to Step 604.

Step 626: Provide the image file.

Step 628: Determine whether the image file is retrieved. If yes, proceed to Step 630. If no, return to Step 604.

Step 630: Place the image file in the waitlist.

Step 632: Determine whether the image searching workflow should be conducted one more time. If yes, return to Step 604. If no, proceed to Step 634.

Step 634: End.

Preferably, the image searching workflow 60 could determine whether the tag of the image file matches the location keyword input by the user, such that if no coordinates information tag is present in the image file, a corresponding coordinates information tag is generated. Despite the fact that the name of the image file stored in the image database is unreadable or the image database does not have a filing system, the present invention could compare the image information section of the image file and the information input by the user to retrieve the desired image file. After the image searching workflow 60 is initiated, keywords input by the user is accepted and image file within the image database is read accordingly. Thereafter, an action is taken to determine whether the image file contains the coordinates information tag. If no coordinates information tag is present, a coordinates information tag is then generated and a position information tag is defined, and an image file having exchangeable image file format is generated according to the coordinates information tag and the position information tag. The image file is compressed thereafter. Conversely, if coordinates information tag is found in the image file, another action is taken to determine whether location information tag is present. If location information tag is not present, the position information tag is translated to location information, whereas if location information tag is present, the location information tag is first translated to location information and the location information is then compared with the keyword input by the user. After the location information matches the keyword, the image file is provided in the waitlist.

Overall, if a search is conducted to look for a digital image file, users do not need to know the name of the file or have a rough impression of the image, but only need to input a few keywords and the related image file can be retrieved successfully. Hence, the present invention not only increases the efficiency of the search, but also improves the usage convenience by categorizing image files into different themes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for searching images applicable to a file database, comprising:
obtaining an image file having an image section and an image information section;
obtaining an identification information;
forming a tag in the image information section according to the identification information;
storing the image file into the file database; and
inputting a search information to search the file database for selecting the image file when the tag matches the search information.

2. The method for searching images applicable to a file database of claim 1 further comprising assigning the tag to a location information, wherein the identification information corresponds to the location information while the image file is obtained.

3. The method for searching images applicable to a file database of claim 2 further comprising:
obtaining a coordinates information while obtaining the image file; and
obtaining the location information from a map system according to the coordinates information.

4. The method for searching images applicable to a file database of claim 1 further comprising:
assigning the identification information to a reference image; and
comparing the image section and the reference image, and assigning the tag to include the identification image when a comparative value between the image section and the reference image being greater than a predetermined value.

5. The method for searching images applicable to a file database of claim 4 further comprising utilizing a correlation between the image section and the reference image for obtaining the comparative value.

6. The method for searching images applicable to a file database of claim 1 further comprising:
assigning the identification information to a captured image, wherein the captured image is selected from a portion of the image section;
selecting a plurality of reference images, wherein each of the reference images comprises a reference label; and
comparing the captured image to the reference images and assigning the tag to include the reference label while a comparative value of one of the reference images being greater than a predetermined value.

7. The method for searching images applicable to a file database of claim 6 further comprising utilizing a correlation between the captured image and the reference images for obtaining the comparative value.

8. The method for searching images applicable to a file database of claim 1 further comprising changing the name of the image file according to the tag.

9. An image processing system, connected to a file database, comprising:
an image receiver for obtaining an image file having an image section and an image information section;
an identification information generator for generating an identification information;
a tag generator for forming a tag within the image information section according to the identification information and storing the image file in the file database; and
an image searching device to input a search information for searching the file database and selecting the image file while the tag matches the search information.

10. The image processing system of claim 9, wherein the identification information generator comprises a positioning device for generating and assigning a coordinates information to the identification information, the tag generator comprises a map system for storing a plurality of coordinates information corresponding to a plurality of location information, such that the tag generator obtains a location information according to the coordinates information in the map system and assigns the location information as the tag.

11. The image processing system of claim 9, wherein the tag generator further comprises:
a memory for storing a plurality of reference images, wherein the identification information corresponds to one of the reference images within the memory; and
a comparison device to compare the image section and the reference image for generating a comparative value, wherein the tag is assigned to include the identification information while the comparative value is greater than a predetermined value.

12. The image processing system of claim 11, wherein the comparative value is obtained from a correlation between the image section and the reference image.

13. The image processing system of claim 9, wherein the identification information corresponds to a captured image, the captured image being a portion of the image from the image section, the tag generator comprises:
a memory for storing a plurality of reference images, wherein each of the reference images comprises a corresponding label; and
a comparison device to compare the captured image and the reference images for generating a corresponding comparative value, wherein the tag is assigned to include the corresponding label while the comparative value is greater than a predetermined value.

14. The image processing system of claim 13, wherein the comparative value is obtained from a correlation between the captured image and the reference image.

15. The image processing system of claim 13, wherein the identification information generator comprises an image capturing device for capturing a portion of the image from the image section as the captured image.

16. A method for searching images applicable to an image database, the image database comprises a plurality of image files, wherein each image file comprises an image section and an image information section, the method comprising:
receiving a search command corresponds to a first image file having a first image section and a first image information section, wherein the first image information section comprises at least one tag;
comparing the tag to every image information section of the image files; and
outputting the corresponding image file while the tag matches the data within the image information section.

17. The method for searching images applicable to an image database of claim 16 further comprising:
obtaining a second image file having a second image section and a second image information section;
obtaining a coordinates information while obtaining the second image file;
obtaining a location information according to the coordinates information and a map system;
recording the location information to the second image information section; and
storing the second image information section to the image database.

18. The method for searching images applicable to an image database of claim 17, wherein the location information is an administrative regional label.

19. The method for searching images applicable to an image database of claim 16, wherein the tag comprises an administrative regional label, a building name, or a shop name.

20. The method for searching images applicable to an image database of claim 16 further comprising:
storing a reference image corresponding to an identification information;
obtaining a third image file having a third image section and a third image information section; and
comparing the third image section and the reference image and storing the identification information into the third image information section while a comparative value between the third image section and the reference image is greater than a predetermined value.

21. The method for searching images applicable to an image database of claim 16 further comprising:
storing a plurality of reference images, wherein each of the reference images corresponds to a corresponding label;
obtaining a fourth image file having a fourth image section and a fourth image information section; and
obtaining a captured image, wherein the capture image being a portion of the fourth image section; and
comparing the captured image and the reference images and recording the corresponding label of the reference image in the fourth image information section while the comparative value of one of the reference images is greater than a predetermined value.

22. An image searching apparatus, the image searching apparatus is connected to an image database having a plurality of image files, each of the image files having an image section and an image information section, the image searching apparatus comprising:
an input device for receiving a search command, wherein the search command corresponds to a first image file having a first image information section, wherein the first image information section stores at least one tag;
a comparison device for comparing the tag and each image information section of the image files, and
an output device for outputting corresponding image file while at least one tag matches the data within the image information section.

23. The image searching apparatus of claim 22 further comprising:
an image receiver for obtaining a second image file having a second image section and a second image information section;
an identification information generator for generating an identification information; and
a tag generator for forming a tag in the second image information section according to the identification information and storing the second image file in the file database.

24. The image searching apparatus of claim 23, wherein the identification information generator comprises a positioning device for generating and assigning a coordinates information to the identification information, the tag generator comprises a map system for storing a plurality of coordinates information corresponding to a plurality of location information, such that the tag generator obtains a location information according to the coordinates information in the map system and assigns the location information as the tag.

25. The image searching apparatus of claim 24, wherein the tag generator further comprises:
a memory for storing a plurality of reference images, wherein the identification information corresponds to one of the reference images within the memory; and
a comparison device to compare the second image section and the reference image for generating a comparative value, wherein the tag is assigned to include the identification information while the comparative value is greater than a predetermined value.

26. The image searching apparatus of claim 23, wherein the identification information corresponds to a captured image, the captured being a portion of the image from the image section, the tag generator comprises:
a memory for storing a plurality of reference images, wherein each of the reference images comprises a corresponding label; and
a comparison device to compare the captured image and the reference images for generating a corresponding comparative value, wherein the tag is assigned to include the corresponding label while the comparative value is greater than a predetermined value.

27. The image searching apparatus of claim 26, wherein the comparative value is obtained from a correlation between the captured image and the reference image.

28. The image searching apparatus of claim 26, wherein the identification information generator comprises an image capturing device for capturing a portion of the image from the image section as the captured image.
